(19) United States
(12) Patent Application Publication
(10) Pub. No.: US 2013/0048238 A1
(43) Pub. Date: Feb. 28, 2013

(54) Oil-Based Creping Release Aid Formulation

(71) Applicants: Daniel E. Glover, Brighton, TN (US); Jian Tan, Bartlett, TN (US)

(72) Inventors: Daniel E. Glover, Brighton, TN (US); Jian Tan, Bartlett, TN (US)

(73) Assignee: BUCKMAN LABORATORIES INTERNATIONAL, INC., Memphis, TN (US)

(21) Appl. No.: 13/590,224

(22) Filed: Aug. 21, 2012

Related U.S. Application Data
(60) Provisional application No. 61/526,091, filed on Aug. 22, 2011.

(51) Int. Cl. C09D 191/00; D21F 11/00

(52) U.S. Cl. 162/111; 106/244; 106/250

(57) ABSTRACT

An oil-based formulation useful as a creping release aid formulation or Yankee dryer coating composition is described. Methods of creping using the oil-based formulation are also described.

This application claims the benefit under 35 U.S.C. §119(e) of prior U.S. Provisional Patent Application No. 61/526,091, filed Aug. 22, 2011, which is incorporated in its entirety by reference herein.

### BACKGROUND OF THE INVENTION

The present invention relates to formulations and, in particular, oil-based formulations, such as oil-based creping release aid formulations or Yankee dryer coating compositions. The present invention further relates to methods for creping that includes such formulations and methods to impart release characteristics and/or properties to the creped product.

The use of lecithin for release agent properties is known for particular formulations such as the ones described in U.S. Pat. No. 5,658,374, which is incorporated in its entirety by reference herein. The particular lecithin-based release composition described in the '374 patent was an aqueous based composition which also used an alcohol component that functioned as a coupling agent and provided freeze/thaw ability. The '374 patent further described the composition as containing a fatty acid or oil and provided examples, such as C₈ to C₂₀ fatty acid, such as oleic acid, linoleic acid, or tall oil fatty acid. The aqueous based formulation further contained water, preferably in the amount of 45 wt % to 50 wt %, so as to ensure formation of an oil-in-water emulsion. While this formulation had release characteristics, this formulation was less effective in providing desirable release characteristics for Yankee dryer or creping processes, as further shown in the examples, which provide comparative data.

The formulation in the '374 patent, which is aqueous-based, has proven to be less effective than desired and, therefore, an improved formulation specifically designed for Yankee dryer coating applications and creping release applications is needed, and, preferably, a formulation that imparts not only release characteristics, but preferably one or more properties to the actual creped product, such as, but not limited to, providing better release characteristics (e.g., having a lower force of adhesion, which is a measurement of the amount of force required to remove an object from a film, which is a simulation to release characteristics on a Yankee dryer or roller).

Thus, there is an existing need and desire for improved Yankee dryer coating compositions or creping release aid formulations.

### SUMMARY OF THE PRESENT INVENTION

It is a feature of the present invention to provide oil-based formulations.

A further feature of the present invention is to provide an oil-based creping release aid formulation.

An additional feature of the present invention is a Yankee dryer coating composition having desirable release characteristics.

A further feature of the present invention is to provide an oil-based creping release aid formulation that, in the presence of one or more adhesives, provides desirable release characteristics of the tissue product on the Yankee dryer so as to be creped to form a creped product.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

The foregoing features have been accomplished in accordance with this invention by providing an oil-based formulation containing at least one vegetable oil; at least one lecithin; at least one dispersant/emulsifier; and water. The water present in the oil-based formulation is optional and, if present, can be an amount by weight that is the lowest of all components present. The vegetable oil(s) can be the largest weight percent component present in the formulation. As an option, at least two dispersants/emulsifiers can be present or at least three dispersants/emulsifiers can be present. As an option, at least one solvent can be present, such as an alcohol or fatty alcohol. As an option, at least one fatty acid can be present, such as a tall oil fatty acid.

In the present invention, the oil-based formulation and the components therein can be food-grade and/or non-toxic, and/or can be entirely or primarily (over 50 wt %, over 75 wt %, over 90 wt %) from renewable resources.

The present invention further relates to a method of creping that includes the use of the oil-based formulation of the present invention. For instance, the use can be or include the application of the oil-based formulation (e.g., diluted in water to lower the concentration) on a Yankee dryer or similar roller prior to, during, or after application of the paper product that is to be creped or subjected to creping. The oil-based formulation of the present invention can be used in other release applications in the paper industry or other industries.

It is to be understood that both the foregoing general description and the following detailed description are exemplary and explanatory only and are intended to provide a further explanation of the present invention, as claimed.

The accompanying drawings, which are incorporated in and constitute a part of this application, illustrate some of the features of the present invention and together with the description, serve to explain the principles of the present invention.

### BRIEF DESCRIPTION OF DRAWINGS

FIG. 1 is a flow chart illustrating a process according to the present invention.

FIG. 2 is a graph plotting the force of adhesion over time for a formulation of the present invention, a control, and a comparative formulation.

FIG. 3 is a graph plotting the force of adhesion over time for a formulation of the present invention, a control, and a second comparative formulation.

### DETAILED DESCRIPTION OF THE PRESENT INVENTION

The present invention relates to oil-based formulations, such as oil-based creping release aid formulations or Yankee dryer coating compositions or a TAD fabric release aid, which provide release characteristics to a fiber web, when the fiber web is on the Yankee dryer or dryer surface. The formulations of the present invention can also be useful as TAD fabric release aids.

The oil-based formulation contains at least one natural oil, such as at least one vegetable oil, at least one lecithin, and at least one dispersant/emulsifier, and, optionally, water.

In the concentrated form, the vegetable oil(s), by weight percent, can be the highest weight percent component present in the oil-based formulation. The water, out of all of the components that form the oil-based formulation, can be the lowest, by weight percent, component present in the oil-based formulation.

The at least one natural oil can be or include one vegetable oil, a combination of two, three, four, or more different types of vegetable oils. The amount of the natural oil present in the oil-based formulation can be over 50% by weight, based on the total weight of the oil-based formulation, such as 50-75 wt %, 55-75 wt %, 60-75 wt %, 65-75 wt %, 70-75 wt %, 55-65 wt %, or other amounts within these ranges. Examples of the natural oil include, but are not limited to, vegetable oils, such as soybean oil, canola oil, corn oil, palm cornel oil, coconut oil, rape seed oil, sunflower oil (sunflower seed oil), peanut oil, olive oil, triglycerides (such as from a renewable resource), or any combinations thereof.

The lecithin can be natural or can be modified by hydroxylation or acetylation or otherwise modified. Lecithin is sold commercially by Solae. Solec HR lecithin can be used. The lecithin can be or include soy lecithin or sunflower lecithin or any combinations thereof. The lecithin can be a combination of two or more different types of lecithin. The lecithin can be present in the oil-based formulation in an amount (based on the total weight percent of the oil-based formulation) of from 10 wt % to 30 wt %, 15 wt % to 30 wt %, 20 wt % to 30 wt %, 25 wt % to 30 wt %, 15 wt % to 25 wt %, or other amounts within these ranges.

With regard to the dispersant/emulsifier, at least one dispersant/emulsifier is present, such as at least two dispersants/emulsifiers or at least three dispersants/emulsifiers. The dispersant/emulsifier can be or include an alkoxylated castor oil ester, one or more polysorbates (such as a sorbitan oleate or sorbitan monolaurate), an alkoxylated alcohol, such as an ethoxylated alcohol (e.g., TOMADOL alkoxylated alcohols from Air Products, for instance, TOMADOL 1-5, 1-7, 1-73B, 1-9, or 25-3, or from Harcros). With regard to the alkoxylated alcohol, such as an ethoxylated alcohol, the molecular weight (average) can be, for instance, from about 300 MW to about 1,000 MW, such as 400 to 750 MW, 400 to 600 MW, and the like. The alkoxylated alcohol can be linear or branched. The EO groups (average) can be from 3 to 12 or 3 to 11, such as from 3 to 9. The EO content (weight percent) can be from 30 wt % to 75 wt %, such as from 40 wt % to 70 wt %, 50 wt % to 70 wt %. The HLB can be from 7 to 15, such as 8 to 14, or 10 to 14. The alkoxylated alcohol can have 3-6 moles of ethylene oxide and/or 3 to 12 carbon atoms.

The alkoxylated castor oil ester can be an ethoxylated castor oil ester, such as a T-Det C-40, available from Harcros. The alkoxylated castor oil, such as an ethoxylated castor oil ester, can have from 20 to 60 moles of EO, such as from 30 to 50 moles, or 40 to 50 moles, and the like. The alkoxylated castor oil ester, such as the ethoxylated castor oil ester, can have a fatty acid end carbon number, such as from 10 to 20, 12 to 18, or 15 to 16.

The polysorbate can be at least one polysorbate, at least two, or at least three. The polysorbate can be Polysorbate 20, Polysorbate 40, Polysorbate 60, and/or Polysorbate 80. The polysorbates can have 20 oxyethylene groups in the molecule. More specific examples are provided below.

With regard to the sorbitan oleate (a.k.a., sorbitan mono oleate), one example can be SPAN 80. The sorbitan oleate can be a sorbitan (Z)-mono-9-octadecenoate. The sorbitan oleate can be a SPAN 20, SPAN 40, SPAN 60, and/or SPAN 80.

With regard to the sorbitan monolaurate, commercial sources include Ivanhoe and Lambent.

With regard to the dispersant/emulsifier, the combined amount, if more than one dispersant/emulsifier is present, can be from 5 wt % to 35 wt % (based on the total weight of the oil-based formulation). Other examples includes weight percents of from 10 wt % to 35 wt %, 15 wt % to 35 wt %, 20 wt % to 35 wt %, 25 wt % to 35 wt %, 30 wt % to 35 wt %, 10 wt % to 20 wt %, or other amounts within these ranges. When more than one dispersant/emulsifier is present, the ratios amongst each dispersant/emulsifier can be on a 1:1 weight ratio, 2:1 weight ratio, 3:1 weight ratio, 4:1 weight ratio, 5:1 weight ratio, or any weight ratio ranging from 1:20 to 20:1. When three dispersants/emulsifiers are present, the weight ratios can be evenly divided on a 1:1:1 basis, or can be present at various other ratios, such as 1:1:15 to 15:1:1 to 1:15:1, or any ratios in between any of these weight ratio ranges. When more than one dispersant/emulsifier is present, the weight percent of each one can be within ±1 wt %, ±5 wt %, ±10 wt %, ±15 wt %, ±20 wt %, ±25 wt %, ±30 wt % of each other. As an example, one or each dispersant/emulsifier can be present in an amount of from 1 wt % to 5 wt % or more, such as 2 wt % to 4 wt %, based on the weight percent of the oil-based formulation.

As an option, at least one solvent can be present in the oil-based formulation of the present invention. The solvent can be one solvent, two solvents, three solvents, or four or more types of solvents. The solvent can be present in any amount, such as from about 0.1 wt % to 5 wt %, such as from about 0.1 wt % to about 3 wt %, or from about 0.5 wt % to about 4 wt % based on the weight percent of the oil-based formulation. The solvent can be an alcohol(s), which can include the class of fatty alcohols. One example of an alcohol that can be used in the present invention is a primary alcohol. For instance, the primary alcohol can contain one or more types of carbon chain isomers. For instance, the alcohol can contain one or more C₈ to C₁₄ carbon chain isomers; for instance, C₁₀ to C₁₃ carbon chain isomers. A more particular example is an alcohol that contains C₁₂ and C₁₃ carbon chain isomers. For instance, the alcohol can be considered an isomeric C₈-C₁₄ primary alcohol, an isomeric C₁₀-C₁₃ primary alcohol, an isomeric C₁₂-C₁₃ primary alcohol, and the like. Commercial sources can be Sasol, under the product name SAFOL alcohol, such as SAFOL 23 alcohol, and the like. The alcohols that can be used in the present invention can be or consist of linear end branched isomers, such as linear end mono-methyl branched isomers in various ratios. For instance, the alcohol can contain from about 30% to 75% linear (e.g., 50% to 60% linear), and from 10% to 50% branched isomers (e.g., such as 25% to 35% branched isomers). The alcohol can be present in an amount of from about 0.1 wt % to about 3 wt %, such as from about 0.1 wt % to about 2 wt %, 0.1 wt % to about 1.5 wt %, 0.5 wt % to about 1 wt %, based on the total weight of the oil-based formulation. For purposes of the present invention, the alcohol can be a fatty alcohol, which can be considered an aliphatic alcohol which can contain, for instance, a chain of from 8 to 36 carbon atoms or 8 to 22 carbon atoms, and the like.

As an option, at least one fatty acid can be present. The fatty acid can act as a solvent, co-solvent, and/or a dispersant. One or more fatty acids can optionally be used in the present invention. One example of a suitable fatty acid is a tall oil fatty acid. The fatty acid used in the present invention can be a monomer acid, for instance, one that is obtained from the manufacturing process to make a tall oil fatty acid. Other examples of fatty acids include, but are not limited to, oleic fatty acid, linoleic fatty acid, stearic fatty acid, isostearic fatty acid, lauric fatty acid, or other fatty acids derived from corn oil or other agricultural oils, such as soy, safflower, rapeseed, and the like. If the fatty acid(s) is present, which is optional, the fatty acid can be present in an amount of from 0.5 wt % to about 5 wt %, such as from about 0.5 wt % to about 4 wt %, such as from about 1 wt % to about 2 wt %, based on the total weight of the oil-based formulation of the present invention. For purposes of the present invention, the fatty acid can include liquid fatty acids derived from or a derivative of oils as mentioned above. Thus, for purposes of the present invention, the fatty acid can be considered a fatty acid derivative or an oil that has been ethoxylated or alkoxylated.

The water, if present in the concentrated formulation, can be present in an amount of from 0 wt % to 10 wt %, 0.1 wt % to 10 wt %, 0.5 wt % to 10 wt %, 1 wt % to 10 wt %, 1.5 wt % to 10 wt %, 2 wt % to 10 wt %, 5 wt % to 10 wt %, 1 wt % to 5 wt %, 2 wt % to 5 wt %, or any amounts within these ranges, wherein the weight percents are based on the total weight percent of the oil-based formulation.

The oil-based formulation can be considered a blend, wherein each of the components in preparing the oil-based formulation can be mixed or otherwise combined together to form a formulation. Conventional mixing equipment, such as a tank with an agitator or in-line mixing using a static mixer, can be used to mix the components together. In preparing the formulation, any order of addition of the various components can be used to form the formulation.

The oil-based formulation can be considered an oil-based creping release aid formulation that can be diluted with water. The oil-based formulation of the present invention can be considered a Yankee dryer coating composition or Yankee dryer release coating composition that can be diluted with water. The oil-based formulation can be considered a TAD release aid formulation that can be diluted. The oil-based formulation can be diluted to form various percents of active amounts, such that the oil-based formulation is present in an amount of from 1 wt % to 20 wt %, 1 wt % to 15 wt %, 1 wt % to 10 wt %, 1 wt % to 7.5 wt %, 1 wt % to 5 wt %, or 1 wt % to 2.5 wt %, based on the total weight of the diluted formulation.

The oil-based formulation, as an option, can have no thickener present and/or it can have no stabilizer present. As an option, no glycol component is present in the oil-based formulations.

The oil-based formulation (e.g., in diluted form as indicated above) can be applied to a Yankee dryer or other cylindrical dryer used in a creping process that rotates. The oil-based formulation can be applied on a continuous basis, semi-continuous basis, intermittent basis, or a one time basis to the cylindrical dryer surface prior to rotating, during rotation, or both. The oil-based formulation of the present invention can be applied to the surface of the cylindrical dryer, to the fiber web prior to being applied onto the cylindrical dryer surface, or during application of the fiber web onto the cylindrical dryer surface, and/or after the fiber web application to the cylindrical dryer surface. The oil-based formulation of the present invention can be applied in combination with one or more creping adhesives or the formulation can be applied before and/or during and/or after the application of a creping adhesive(s). The oil-based formulation of the present invention can be mixed with one or more adhesives (e.g., creping adhesive(s)) to form a formulation that can be applied onto the cylindrical dryer surface prior to the fiber web contacting the surface or after the fiber web contacts the cylindrical dryer surface or both. The oil-based formulation can be applied separately from the adhesive by the use of two different spray nozzles or, as indicated, a formulation that contains both can be sprayed through a single spray nozzle or multiple spray nozzles. The application rate or use rate of the oil-based formulation, alone or combined with an adhesive and/or other components, can be from 0.1 m g/m² of dryer surface to 20 mg/m² of dryer surface, such as from 1 to 5 mg/m² surface or 1 to 2.5 mg/m² of dryer surface. With the present invention, it is possible to significantly reduce the use rate and yet achieve comparable release properties. For instance, it is typical that the adhesive plus release aid formulation is applied in an amount of 5 to 10 mg/m², and yet with the present invention, an amount of from 1 to 2.5 mg/m² can be applied and achieve comparable release properties. Thru-air drying can use even higher amounts as an option. Thru-air drying can range from 0.1 m g/m² to 100 mg/m² of dryer surface, such as from 10 mg/m² to 80 mg/m² of dryer surface, or from 20 mg/m² to 70 mg/m² of dryer surface

Examples of creping adhesives include, but are not limited to, polyamide amine epichlorohydrin polymers. Other examples of suitable adhesives include BUBOND 2624 or BUBOND 2620, and the like, from Buckman, Memphis, Tenn.

A modifier can be used in addition to the oil-based formulation of the present invention. The modifier can be considered a softening agent and can be any component that softens the film created by the adhesive. Examples include, but are not limited to, a glycerine, cationic surfactant, non-ionic surfactant, glycol, or the like. The modifier can be present, based on the weight percent of the oil-based formulation, adhesive, and modifier (total amount) of from 0 wt % to 50 wt %, such as from 5 wt % to 25 wt %.

The adhesive is present (based on the total amount of adhesive, diluted oil-based formulation, and optional modifier) of from 0.5 wt % to 10 wt %, such as 1 wt % to 5 wt %.

The present invention relates to the manufacture of creped paper including soft, absorbent tissue paper webs and particularly to the mode of creping of such webs to attain adequate softness and adhesive characteristics in the web while minimizing operational difficulties. The paper web that is creped can be obtained from virgin pulp sources and/or from recycled sources, such as mixed office waste. The present invention is particularly useful with paper webs formed from or including mixed office waste recycled sources, or sorted office papers.

It is known in the art to form a thin paper web from a slurry of water and fiber, dewater the wet web, and then at least partially dry the dewatered web. The web is then conveyed or carried on a fabric to a large steam-heated rotary drum termed in the art a Yankee dryer. The web commonly enters the dryer at a circumferential dryer position which is a major portion around the dryer from the zone of web de-contact from the drum. The de-contact zone is equipped with a creping blade against which the web abuts so as to be pushed backwardly upon itself and attain the well-known tissue crepe paper structure.

The creping action requires that the web be well adhered to the dryer to effect a consistent and uniform creping action, and for example, to prevent flaring of the web from the dryer before or at the exit zone in the vicinity of the creping blade. In some instances, the web is presented to the dryer at a considerable moisture content that is typically as high as about 60%. Such webs accordingly have fiber consistencies at the point of contact with the dryer of about 40%. The moisture content, depending upon the condition of the web surface and the Yankee dryer surface, may tend to cause the web to adhere strongly to the dryer throughout the drying action of the rotating drum. Under such circumstances, there is usually no requirement for the use of a supplemental adhesive, and on some occasions, the adhesion to the dryer is so tight that a release agent is applied between the dryer and the web to limit the extent of adhesion.

In some modes of operation, commonly referred to as through-drying (also known as through air drying or TAD), contact of the web with the dryer surface is limited. In a through-drying operation, the web formed from the slurry of water and fiber is dewatered without significantly pressing the wet web. This is followed by a drying action in a hot air blast. The resulting webs are then pressed to the Yankee dryer using a knuckled fabric so that the web adheres to the dryer in closely spaced zones, with bulking of the web between the zones. Fabrics having as fine a count as 4,900 openings per square inch and above may serve the purpose. The fiber consistency of such webs when presented to the dryer may be from about 30% to about 90% fiber. Higher fiber-consistency webs commonly require an adhesive to adequately secure the web to the dryer for completion of both the drying action and creping action.

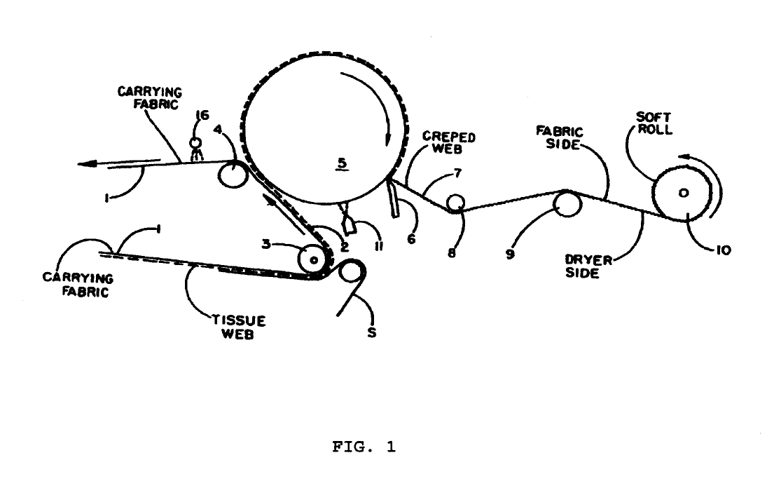

According to the present invention, a method of manufacturing crepe paper is provided, including soft, absorbent tissue paper webs, and particularly to modes of creping of such webs to attain adequate softness and adhesive characteristics while minimizing operational difficulties. According to the present invention, a thin paper web is formed from a slurry of water and fiber using a conventional web forming technique. The web is then dewatered and preferably is at least partially dried. The web is then conveyed, for example, carried on a fabric, to a large preferably steam-heated rotary drum dryer, referred to herein and elsewhere as a Yankee dryer. The web commonly enters the dryer at a circumferential dryer position that is preferably at least about halfway around, and more preferably at least about 75% around, the cylindrical dryer with respect to the zone of web de-contact from the drum. The de-contact zone is equipped with a creping blade against which the web abuts so as to be pushed backwardly upon itself and attain the well-known tissue crepe paper structure. Referring to FIG. 1, the belt designated reference numeral 1 carries the formed, dewatered and partially dried web 2 around turning roll 3 to the nip between press roll 4 and Yankee dryer 5. A supplemental lower carrier designated at S may also be employed to carry the web in sandwich fashion, which may be particularly useful under conditions of higher web dryness. The fabric, web, and dryer move in the directions indicated by the arrows. The entry of the web into the dryer is well around the roll from creping blade 6, which, as is schematically indicated, crepes the traveling web from the dryer as indicated at 7. The creped web 7 exiting from the dryer passes over guide and tension rollers 8, 9 and is wound into a soft creped tissue roll 10.

To adhere the relatively dry web 2 (at, for example, 80% fiber consistency) entering the dryer to the surface of the dryer, a spray 11 of the present invention can be applied to the surface ahead of the nip between the press roll 4 and Yankee dryer 5. This spray may be applied to the traveling web 2 directly but is preferably directly sprayed onto the dryer to limit the pickup of adhesive by the web and to limit the penetration of adhesive through the web to the carrying fabric.

The creping action is facilitating by ensuring that the web is well-adhered to the dryer to effect a consistent and uniform creping action, and for example, to prevent flaring of the web from the dryer before or at the exit zone in the vicinity of the creping blade. In some instances, the web is presented to the dryer at a considerable moisture content of up to about 90% by weight based on the weight of the web. Webs having moisture contents of from about 10% by weight to about 90% by weight, and more particularly from about 40% by weight to about 60% by weight, can be processed according to the methods of the present invention. Such webs accordingly would have fiber contents making up the additional weight % of the web. The moisture content, depending upon the condition of the web surface and the Yankee dryer surface, may tend to cause the web to adhere strongly to the dryer throughout the drying action of the rotating drum.

Creping systems, methods, and adhesives are described in the following U.S. Patent Nos. which are incorporated herein in their entireties by reference: U.S. Pat. Nos.3,640,841; 4,304,625; 4,440,898; 4,788,243; 4,994,146; 5,025,046; 5,187,219; 5,326,434; 5,246,544; 5,370,773; 5,487,813; 5,490,903; 5,633,309; 5,660,687; 5,846,380; 4,300,981; 4,063,995; 4,501,640; 4,528,316; 4,886,579; 5,179,150; 5,234,547; 5,374,334; 5,382,323; 5,468,796; 5,902,862; 5,942,085; 5,944,954; 3,879,257; 4,684,439; 3,926,716; 4,883,564; and 5,437,766.

With the use of the oil-based formulations of the present invention, superior release properties of the fiber web from the surface of the dryer can be achieved. Comparable or better release properties at a lower use rate than petroleum-based release agents can be obtained. The present invention is not a water-based emulsion, but an oil-based formulation prior to being diluted with water in order to make a formulation that is applied to the dryer surface.

The oil-based formulation of the present invention can be considered the concentrated product, which can be diluted, such as on site of the creping location in a mix pot or in line with other materials that are to be sprayed on the cylindrical dryer.

Ideally, the diluted oil-based formulation of the present invention, either alone or in combination with one or more adhesives, and/or one or more modifier/softening agents can partially dry before the wet fiber web is applied onto the cylindrical dryer surface. The fiber web can then be pressed onto the cylindrical dryer surface and then creped from the cylindrical dryer surface by way of a creping blade that impacts wrinkles and/or a crepe pattern to the fiber web or sheet. The process of the present invention, especially in view of the oil-based formulation of the present invention, provides an improved creping pattern, a softer feel to the sheet, increased stretch (which improves the ability to convert the sheet to the final tissue product), or a bulky soft sheet.

The creping process and details set forth in U.S. Pat. No. 6,991,707 can be applied in this invention using the oil-based formulation of the present invention, and this patent is incorporated in its entirety by reference herein.

The oil-based formulation of the present invention can be used in other release applications of the paper industry or other industries. For instance, the formulation can be used as a release aid for moulds or presses that form paper articles, such as, but not limited to, paper plates, egg cartons, fruit trays, and the like. The formulation can be useful as a release aid in flat paper machines and/or as a release aid in any roll, roller, or dryer using in machines.

The oil-based formulation of the present invention can be considered biodegradable, and/or non-toxic, and/or contains one or more food-grade components.

The oil-based formulations of the present invention are storage stable, meaning that the components that form the oil-based formulation will not separate or settle over time. For instance, the storage stability of the oil-based formulations of the present invention can be at least 20 days, at least 30 days, or at least 45 days at a storage temperature of from 0° C. to 50° C. During this time period, the ingredients that form the oil-based formulation will not separate or settle to any significant degree (e.g., less than 5 wt %, less than 1 wt % (based on the total weight of the oil-based formulation) will separate or settle during this time period and, preferably, 0.1 wt % to 0 wt % will separate or settle during this time period).

The present invention will be further clarified by the following examples, which are intended to be exemplary of the present invention.

### EXAMPLES

### Example 1

In this example, a comparison was made between a formulation of the present invention and a formulation from U.S. Pat. No. 5,658,374. Specifically, Example 1 in the '374 patent was reproduced (to the extent possible), and this formulation was then used in a test to simulate release characteristics.

The oil-based formulation of the present invention was prepared by mixing the following ingredients together to form a blend.

| | Content |
|---|---|
| Chemical | (by weight) |
| Lecithin HR | 20% |
| Vegetable Oil (Canola Oil | 63% |
| or Soybean Oil) | |
| C-40 (Castor Oil Ester with | 5% |
| 40 Moles of EO) | |
| Span 80 | 5% |
| Tomadol 1-7 | 5% |
| H₂O | 2% |
| Total | 100% |

As a comparison, an oil-in-water emulsion was prepared by mixing the following components together:
Water (66 wt %)
Veegum—magnesium aluminum silicate (0.22 wt %)
Propylene glycol (2.2 wt %)
Toximul 8320—butoxy block copolymer of ethylene oxide and propylene oxide (1.1 wt %)
Xanthan gum (0.11 wt %)
Industrene 106—oleic acid (24 wt %)
Centrophase HR—lecithin (6 wt %)

In each formulation, the adhesive used was Buckman's BUBOND 2620. The adhesive was diluted in the deionized water to obtain a solids content (actives content) of 2.5 wt %.

The release agent of the present invention and the formulation from Example 1 of the '374 patent were each mixed with the diluted adhesive to obtain a concentration of 0.25 wt % release agent in each respective diluted formulation.

These two formulations were then subjected to a simulated roller test, which is known as a tackiness tester.

Specifically, the combined release/adhesive mixture of the present invention and from the '374 patent were applied to two separate metal plates having at least one hole in the metal plate to receive a probe. The tip of the probe was covered in a cotton cloth. In the test, the mixture, in an amount of 5 mg/m², was applied onto the plate, and the plate was subjected to a temperature of 140° C. for 10 minutes to cure the adhesive/release formulation of the present invention and of the '374 patent. Then, the temperature of the plate was raised to 170° C., and the probe with the cotton cloth was inserted into the hole of the metal plate at a force of 200 g for 5 seconds, and then removed and the amount of force to remove the probe from the metal plate a distance of ½ cm at a speed of 5 cm/minute was removed. This test was repeated 9 times every 30 seconds. Thus, 10 measurements were obtained

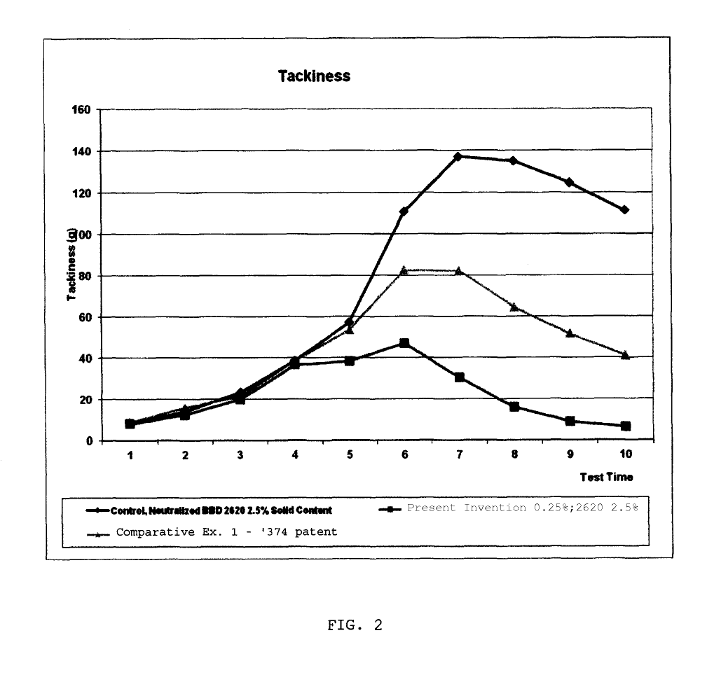

The results for the release characteristics for the formulation of the present invention compared to the formulation of the '374 patent are set forth in FIG. 2. In addition, as part of the test, a control which contained no release formulation, but only the adhesive in the same amount, was further conducted on the tackiness tester. As shown in FIG. 2, the force of adhesion was the highest for the control, which was expected since it contained adhesive and no release agents. The force of adhesion for Example 1 of the '374 patent had better release characteristics than the control, but had almost 50% more tackiness/adhesive qualities compared to the release achieved with the formulation of the present invention. In other words, the release characteristics for the formulation of the present invention was significantly better (as shown in FIG. 2 with the lower force of adhesion) compared to the formulation of the '374 patent This test shows that the release characteristics of the formulations of the present invention would perform better in a creping process since there is sufficient adhesion in order to keep the web on the cylindrical dryer, but this force of adhesion is balanced with sufficient release qualities such that the fiber web will release from the cylindrical dryer at the appropriate time when contacted by the creping blade.

### Example 2

The oil-based formulation of the present invention, as used in Example 1, was further compared to a crude oil-based formulation and to a control that contained no release formulation. The crude oil-based release formulation was a commercially-available product from Buckman, namely BUSPERSE 2032. This release formulation primarily contains light-weight crude oil and a surfactant, and is considered a very typical release agent used currently by the creping industry.

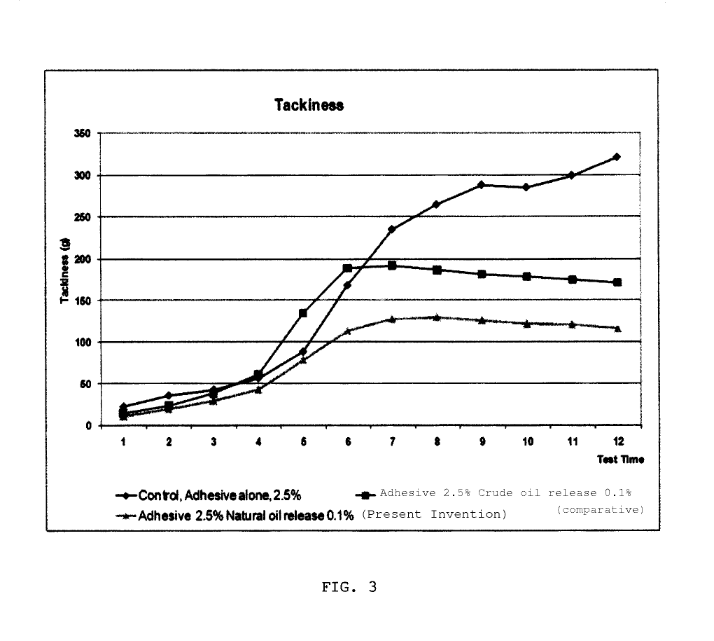

The same dilution rates and combination with an adhesive, as done in Example 1, was repeated here, except the release aid concentration was 0.1 wt % (instead of 0.25 wt %) and the test was conducted 12 times instead of 10 times. As can again be seen by the results shown in FIG. 3, the control adhesive which contained no release agent had the highest tackiness over time, and the adhesive/crude oil formulation had almost 50% more tackiness compared to the adhesive/release formulation of the present invention, again showing that the present invention achieved desirable release characteristics, but maintained sufficient tackiness for purposes of use in a creping process.

### Example 3

A different oil-based formulation of the present invention was used in this example, and was prepared by mixing the following ingredients together to form a blend.

| | Content |
|---|---|
| Chemical | (by weight) |
| Lecithin HR (soy lecithin) | 20% |
| Vegetable Oil (Canola Oil | 68% |
| or Soybean Oil) | |
| Safol 23 linear/isomeric | 1% |
| alcohol | |
| Polysorbate 80 | 3% |
| Tomadol 1-5 | 3% |
| Tall Oil Fatty Acid | 2% |
| Sorbitan monolaurate | 3% |
| H₂O | 0% |
| Total | 100% |

This formulation was further compared to a crude oil-based formulation and to a control that contained no release formulation. The crude oil-based release formulation was a commercially-available product from Buckman, namely BUSPERSE 2032. This release formulation primarily contains light-weight crude oil and a surfactant, and is considered a very typical release agent used currently by the creping industry.

The same dilution rates and combination with an adhesive, as done in Example 1, was repeated here, except the release aid concentration was 0.1 wt % (instead of 0.25 wt %) and the test was conducted 10 times. The control adhesive which contained no release agent had the highest tackiness over time (about 220 g tack), and the adhesive/crude oil formulation had almost 25% more tackiness (about 90-95 g tack) compared to the adhesive/release formulation of the present invention (about 60 g tack), again showing that the present invention achieved desirable release characteristics, but maintained sufficient tackiness for purposes of use in a creping process.

The present invention includes the following aspects/embodiments/features in any order and/or in any combination:

1. The present invention relates to an oil-based formulation comprising:

a) at least one vegetable oil;

b) at least one lecithin;

c) at least one dispersant/emulsifier; and optionally

d) water,

wherein the at least vegetable oil is present in the highest weight percent and the water, if present, is present in the lowest weight percent in said oil-based formulation.

2. The oil-based formulation of any preceding or following embodiment/feature/aspect, further comprising at least one solvent.

3. The oil-based formulation of any preceding or following embodiment/feature/aspect, further comprising at least one alcohol.

4. The oil-based formulation of any preceding or following embodiment/feature/aspect, further comprising at least one fatty acid.

5. The oil-based formulation of any preceding or following embodiment/feature/aspect, further comprising at least one alcohol and at least one fatty acid.

6. The oil-based formulation of any preceding or following embodiment/feature/aspect, wherein said alcohol is a primary alcohol containing C₈-C₁₄ carbon chain isomers.

7. The oil-based formulation of any preceding or following embodiment/feature/aspect, wherein said alcohol is a primary alcohol containing C₈-C₁₄ carbon chain isomers, and wherein said fatty acid is a tall oil fatty acid.

8. The oil-based formulation of any preceding or following embodiment/feature/aspect, wherein said alcohol is a primary alcohol containing C₁₀-C₁₃ carbon chain isomers.

9. The oil-based formulation of any preceding or following embodiment/feature/aspect, wherein said at least one vegetable oil is present in an amount of from 50 wt % to 75 wt %; the at least one lecithin is present in an amount of from 10 wt % to 30 wt %; the at least one dispersant/emulsifier is present in an amount of from 5 wt % to 35 wt %; and said water is present in an amount of from 0 wt % to 10 wt %, wherein said weight percents are based on the total weight percent of the oil-based formulation.

10. The oil-based formulation of any preceding or following embodiment/feature/aspect, wherein said at least one vegetable oil is present in an amount of from 50 wt % to 75 wt %; the at least one lecithin is present in an amount of from 10 wt % to 30 wt %; the at least one dispersant/emulsifier is present in an amount of from 5 wt % to 35 wt %; and said water is present in an amount of from 0 wt % to 5 wt %, and said alcohol is present in an amount of from 0.1 wt % to 3 wt %, and said fatty acid is present in an amount of from 0.5 wt % to about 4 wt %.

11. The oil-based formulation of any preceding or following embodiment/feature/aspect, wherein said at least one dispersant/emulsifier comprises at least one polysorbate.

12. The oil-based formulation of any preceding or following embodiment/feature/aspect, wherein said at least one vegetable oil is soybean oil, canola oil, corn oil, palm cornel oil, coconut oil, rape seed oil, sunflower oil, peanut oil, olive oil, or any combinations thereof, the at least one dispersant/emulsifier comprises at least one polysorbate, and at least one alkoxylated alcohol.

13. The oil-based formulation of any preceding or following embodiment/feature/aspect, wherein said at least one vegetable oil is soybean oil, canola oil, corn oil, palm cornel oil, coconut oil, rape seed oil, sunflower oil, peanut oil, olive oil, or any combinations thereof.

14. The oil-based formulation of any preceding or following embodiment/feature/aspect, wherein said lecithin is natural lecithin.

15. The oil-based formulation of any preceding or following embodiment/feature/aspect, wherein at least one dispersant/emulsifier is at least two dispersants/emulsifiers.

16. The oil-based formulation of any preceding or following embodiment/feature/aspect, wherein at least one dispersant/emulsifier is at least three dispersants/emulsifiers.

17. The oil-based formulation of any preceding or following embodiment/feature/aspect, wherein said at least one dispersant/emulsifier is alkoxylated castor oil ester, sorbitan oleate, alkoxylated alcohol, or any combinations thereof.

18. The oil-based formulation of any preceding or following embodiment/feature/aspect, wherein said at least dispersant/emulsifier is a combination of an alkoxylated castor oil ester, sorbitan oleate, and an alkoxylated alcohol.

19. The oil-based formulation of any preceding or following embodiment/feature/aspect, wherein said at least one vegetable oil is canola oil or soybean oil, and said at least one dispersant/emulsifier is a combination of an ethoxylated castor oil ester, sorbitan oleate, and an ethoxylated alcohol.

20. The oil-based formulation of any preceding or following embodiment/feature/aspect, wherein the at least one vegetable oil is canola oil or soybean oil in an amount of from 50 wt % to 75 wt %, the lecithin is present in an amount of from 10 wt % to 30 wt %, the at least one dispersant/emulsifier is a combination of an alkoxylated castor oil ester, a sorbitan oleate, and an ethoxylated alcohol in a combined amount of from 5 wt % to 35 wt %, and water in an amount of from 0 wt % to 5 wt %, based on the total weight percent of the oil-based formulation.

21. A process for creping a fiber web, comprising providing a rotating cylindrical dryer, including a dryer surface,

applying a formulation comprising the oil-based formulation of claim 1 to the dryer surface,

conveying a fiber web to the dryer surface,

drying the fiber web on said dryer surface to form a dried fiber web, and

creping the dried fiber web from the dryer surface.

22. The process of any preceding or following embodiment/feature/aspect, wherein at least one adhesive and, optionally, at least one modifier or softening agent are applied in combination with said formulation.

23. The process of any preceding or following embodiment/feature/aspect, wherein said formulation comprises the oil-based formulation and water, wherein said water is present in the amount of from 10 wt % to 30 wt %.

24. The process of any preceding or following embodiment/feature/aspect, wherein said adhesive comprises PAE.

25. The process of any preceding or following embodiment/feature/aspect, wherein said fiber web comprises pulp obtained from recycled mixed office waste.

26. The process of any preceding or following embodiment/feature/aspect, wherein said formulation comprises at least one adhesive and said oil-based formulation and optionally at least one modifier.

27. The process of any preceding or following embodiment/feature/aspect, wherein said formulation comprises at least one creping adhesive in an amount of from about 0.5 wt % to 3 wt %, the oil-based formulation in an amount of from about 0.5 wt % to 5 wt %, and the balance being water, wherein all weight percents are based on the total weight of the formulation.

28. The method of any preceding or following embodiment/feature/aspect, wherein said formulation is applied in an amount of from about 0.5 mg/m² of dryer surface to 5 mg/m² of dryer surface.

29. The method of any preceding or following embodiment/feature/aspect, wherein said formulation is applied in an amount of from about 1 m g/m² of dryer surface to 2.5 mg/m² of dryer surface.

The present invention can include any combination of these various features or embodiments above and/or below as set forth in sentences and/or paragraphs. Any combination of disclosed features herein is considered part of the present invention and no limitation is intended with respect to combinable features.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. An oil-based formulation comprising:
a) at least one vegetable oil;
b) at least one lecithin;
c) at least one dispersant/emulsifier; and optionally
d) water,
wherein the at least vegetable oil is present in the highest weight percent and the water, if present, is present in the lowest weight percent in said oil-based formulation.

2. The oil-based formulation of claim 1, further comprising at least one solvent.

3. The oil-based formulation of claim 1, further comprising at least one alcohol.

4. The oil-based formulation of claim 1, further comprising at least one fatty acid.

5. The oil-based formulation of claim 1, further comprising at least one alcohol and at least one fatty acid.

6. The oil-based formulation of claim 5, wherein said alcohol is a primary alcohol containing C₈-C₁₄ carbon chain isomers.

7. The oil-based formulation of claim 5, wherein said alcohol is a primary alcohol containing C₈-C₁₄ carbon chain isomers, and wherein said fatty acid is a tall oil fatty acid.

8. The oil-based formulation of claim 5, wherein said alcohol is a primary alcohol containing C₁₀-C₁₃ carbon chain isomers.

9. The oil-based formulation of claim 1, wherein said at least one vegetable oil is present in an amount of from 50 wt % to 75 wt %; the at least one lecithin is present in an amount of from 10 wt % to 30 wt %; the at least one dispersant/emulsifier is present in an amount of from 5 wt % to 35 wt %; and said water is present in an amount of from 0 wt % to 10 wt %, wherein said weight percents are based on the total weight percent of the oil-based formulation.

10. The oil-based formulation of claim 5, wherein said at least one vegetable oil is present in an amount of from 50 wt % to 75 wt %; the at least one lecithin is present in an amount of from 10 wt % to 30 wt %; the at least one dispersant/emulsifier is present in an amount of from 5 wt % to 35 wt %; and said water is present in an amount of from 0 wt % to 5 wt %, and said alcohol is present in an amount of from 0.1 wt % to 3 wt %, and said fatty acid is present in an amount of from 0.5 wt % to about 4 wt %.

11. The oil-based formulation of claim 1, wherein said at least one dispersant/emulsifier comprises at least one polysorbate.

12. The oil-based formulation of claim 1, wherein said at least one vegetable oil is soybean oil, canola oil, corn oil, palm cornel oil, coconut oil, rape seed oil, sunflower oil, peanut oil, olive oil, or any combinations thereof, the at least one dispersant/emulsifier comprises at least one polysorbate, and at least one alkoxylated alcohol.

13. The oil-based formulation of claim 1, wherein said at least one vegetable oil is soybean oil, canola oil, corn oil, palm cornel oil, coconut oil, rape seed oil, sunflower oil, peanut oil, olive oil, or any combinations thereof.

14. The oil-based formulation of claim 1, wherein said lecithin is natural lecithin.

15. The oil-based formulation of claim 1, wherein at least one dispersant/emulsifier is at least two dispersants/emulsifiers.

16. The oil-based formulation of claim 1, wherein at least one dispersant/emulsifier is at least three dispersants/emulsifiers.

17. The oil-based formulation of claim 1, wherein said at least one dispersant/emulsifier is alkoxylated castor oil ester, sorbitan oleate, alkoxylated alcohol, or any combinations thereof.

18. The oil-based formulation of claim 1, wherein said at least dispersant/emulsifier is a combination of an alkoxylated castor oil ester, sorbitan oleate, and an alkoxylated alcohol.

19. The oil-based formulation of claim 1, wherein said at least one vegetable oil is canola oil or soybean oil, and said at least one dispersant/emulsifier is a combination of an ethoxylated castor oil ester, sorbitan oleate, and an ethoxylated alcohol.

20. The oil-based formulation of claim 1, wherein the at least one vegetable oil is canola oil or soybean oil in an amount of from 50 wt % to 75 wt %, the lecithin is present in an amount of from 10 wt % to 30 wt %, the at least one dispersant/emulsifier is a combination of an alkoxylated castor oil ester, a sorbitan oleate, and an ethoxylated alcohol in a combined amount of from 5 wt % to 35 wt %, and water in an amount of from 0 wt % to 5 wt %, based on the total weight percent of the oil-based formulation.

21. A process for creping a fiber web, comprising providing a rotating cylindrical dryer, including a dryer surface,
applying a formulation comprising the oil-based formulation of claim 1 to the dryer surface,
conveying a fiber web to the dryer surface,
drying the fiber web on said dryer surface to form a dried fiber web, and
creping the dried fiber web from the dryer surface.

22. The process of claim 21, wherein at least one adhesive and, optionally, at least one modifier or softening agent are applied in combination with said formulation.

23. The process of claim 21, wherein said formulation comprises the oil-based formulation and water, wherein said water is present in the amount of from 10 wt % to 30 wt %.

24. The process of claim 22, wherein said adhesive comprises PAE.

25. The process of claim 21, wherein said fiber web comprises pulp obtained from recycled mixed office waste.

26. The process of claim 21, wherein said formulation comprises at least one adhesive and said oil-based formulation and optionally at least one modifier.

27. The process of claim 21, wherein said formulation comprises at least one creping adhesive in an amount of from about 0.5 wt % to 3 wt %, the oil-based formulation in an amount of from about 0.5 wt % to 5 wt %, and the balance being water, wherein all weight percents are based on the total weight of the formulation.

28. The method of claim 21, wherein said formulation is applied in an amount of from about 0.5 mg/m² of dryer surface to 5 mg/m² of dryer surface.

29. The method of claim 21, wherein said formulation is applied in an amount of from about 1 mg/m² of dryer surface to 2.5 mg/m² of dryer surface.
